(19) United States
(12) Patent Application Publication
(10) Pub. No.: US 2013/0090280 A1
(43) Pub. Date: Apr. 11, 2013

(54) CLEANING COMPOSITIONS AND METHODS

(71) Applicants: RAJAT S. BASU, East Amherst, NY (US); KANE D. COOK, Eggertsville, NY (US); RYAN HULSE, Getzville, NY (US); DIANA MERCIER, Detroit, MI (US); GARY M. KNOPECK, Lakeview, NY (US); TODD WHITCOMB, Cheektowaga, NY (US); MARTIN R. PAONESSA, Niagara Falls, NY (US)

(72) Inventors: RAJAT S. BASU, East Amherst, NY (US); KANE D. COOK, Eggertsville, NY (US); RYAN HULSE, Getzville, NY (US); DIANA MERCIER, Detroit, MI (US); GARY M. KNOPECK, Lakeview, NY (US); TODD WHITCOMB, Cheektowaga, NY (US); MARTIN R. PAONESSA, Niagara Falls, NY (US)

(73) Assignee: HONEYWELL INTERNATIONAL INC., MORRISTOWN, NJ (US)

(21) Appl. No.: 13/593,433

(22) Filed: Aug. 23, 2012

Related U.S. Application Data
(60) Provisional application No. 61/566,579, filed on Dec. 2, 2011.
(60) Provisional application No. 61/543,881, filed on Oct. 6, 2011.

(51) Int. Cl. C11D 7/50; C11D 3/43

(52) U.S. Cl. 510/175; 510/461; 510/505; 510/506; 510/502; 510/470; 510/493; 510/495; 510/469; 510/464; 510/528

(57) ABSTRACT

The present invention relates, in part, to compositions including at least one hydrofluoro-olefin or hydrochlorofluoro-olefin solvent. Such compositions may optionally contain one or more alcohols or other co-solvent or agent and may be used to provide one or more cleaning applications.

### CROSS REFERENCES TO RELATED APPLICATIONS

The present application claims priority to U.S. Provisional Application Ser. No. 61/566,579, filed on Dec. 2, 2011, the contents of which is incorporated herein by reference in its entirety. The present application also claims priority to U.S. Provisional Application Ser. No. 61/543,881, filed on Oct. 6, 2011, the contents of which is incorporated herein by reference in its entirety.

### FIELD OF THE INVENTION

The present invention relates to compositions including halo-olefin solvents, which may be used in cleaning applications.

### BACKGROUND OF THE INVENTION

A variety of solvent compositions for cleaning applications, such as dry cleaning, the cleaning of printed circuit boards, metal degreasing, precision cleaning of aerospace components, cleaning of medical devices, and cleaning of small or confined spaces have been utilized. For example, solvent-surfactant compositions based on 1,1,2-trichlorotrifluoroethane (“CFC-113”) are known. Per the Montreal Protocol, however, environmental concerns lead to the phase out of CFC-113 in 1996 for CFC-based systems. Azeotropic mixtures of HCFC-225 (dichloropentafluoropropane) and HCFC-141b with alcohols were adopted by many users as a replacement. However, these compounds also have ozone depletion potential. As a result, 141b was phased-out, and HCFC-225 is currently being phased out.

Subsequently, many alternate solvents and technologies have been introduced in the marketplace and the industry, in general, has gone through a tremendous change. A detailed description of many of these alternates may be found in “Handbook for Critical Cleaning”. See Handbook of Critical Cleaning, ed. Barbara and Ed Kanegsberg, 2^{nd} Edition, CRC Press, FL, 2011, the contents of which are incorporated herein by reference.

Current cleaning technologies can be divided into a few major categories such as solvent, aqueous, semi-aqueous and not-in-kind which includes so-called “no-clean” fluxes. Solvent cleaning has included various hydrocarbons, halogenated hydrocarbons, hydrofloroethers and several others, and blends of these materials with alcohols and other compounds. Aqueous cleaning generally involves the use of water with various detergents. Semi-aqueous generally involves the removal of soils with terpene or citrus based solvents and then washing these materials with water. Each of these cleaning alternatives has disadvantages, and none of them has been able to achieve widespread use over many applications, which was an advantage of CFC-113 prior to the recognition of its environmental problems.

With printed circuit boards, for example, a new problem has arisen that make cleaning them with such solvents difficult. As technology in printed circuit board design is advancing, the line spacing is becoming narrower, components are being spaced closer to the boards, and more surface mount devices are being used. Semi-aqueous and aqueous clean techniques were initially favored to replace CFCs because of their lack of flammability, low price and availability. However, with the advances in printed circuit board design, it has become apparent that the relatively high surface tension of water makes it difficult to penetrate in narrower spacing. The corrosive nature of water can also be problematic. In addition drying is very energy intensive and waste water disposal brings in difficulty in operation. In the case of semi-aqueous techniques, the same problems mentioned above occur, and in addition odor and some flammability are also issues that users have to deal with.

Similar problems exist with cleaning materials have confined or narrow spaces like screw threads, areas of tight clearance, dead end holes, small channels and any other area that has restricted access. Typically confined space cleaning is required in a number of areas such as precision metal, electronics, medical and plastics cleaning.

For dry cleaning, drying, and water displacement, surfactants are required that, together with the chosen solvent, impart distinct, and a difficult to achieve set of properties to the cleaning compositions. For the removal of oil from machined parts, the surfactant will preferably aid in the removal of the soils that would otherwise only be sparingly soluble in such solvents. Additionally, water displacement requires a surfactant that does not cause the formation a stable emulsion with water. Applicants have come to appreciate that halogenated olefin solvents in general, and chloro-fluoro-olefins in particular, present the additional difficulty of identifying combinations of such solvents and surfactants that not only possess the desired solvency and other properties, but which also exhibit an acceptable level of stability since olefins are generally understood to be reactive, especially in comparison to many previously used solvents.

Accordingly, there is a need in the art for new cleaning solvents that may address one or more of the foregoing problems.

### SUMMARY OF THE INVENTION

In one aspect, the present invention relates to compositions including at least one HFO or HCFO solvent. In certain embodiments, the HFO or HCFO has the structure of formula (I):

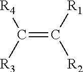

wherein R₁, R₂ R₃, and R₄ are each independently selected from the group consisting of: H, F, Cl, and C₁-C₆ alkyl, at least C₆ aryl, at least C₃ cycloalkyl, and C₆-C₁₅ alkylaryl, optionally substituted with at least one F or Cl, wherein formula (I) contains at least one F. In further embodiments, the HFO or HCFO solvent includes HCFO-1233. In even further embodiments it includes 1-chloro-3,3,3-trifluoropropene (HCFO-1233zd), which may include the cis and/or trans isomer. As indicated below, the present invention contemplates uses where either the cis- or trans-isomer are specifically contemplated. Accordingly, and in certain embodiments, the compositions of the present invention comprise, consist essentially of, or consist of either trans-1-chloro-3,3,3-trifluoropropene HCFO-1233zd(E) or cis-1-chloro-3,3,3-trifluoropropene (HCFO-1233zd(Z)). Such HFO or HCFOs may be provided alone or with one or more co-agents, particularly co-solvents and co-agents that it is miscible therewith.

The compositions of the present application may be used in a variety of applications. In one aspect, such composition(s) are used in a method for cleaning a substrate comprising the steps of contacting the substrate with an effective amount of the composition provided herein and then removing the composition from the substrate. This method may be carried out wherein the composition further comprises one of more co-solvents or co-agents, such as those identified herein. In certain aspects, such methods may be used in dry cleaning applications or in applications where it is desirable to clean confined or narrow spaces.

Additional advantages and embodiments will be readily apparent to one of skill in the art, based on the disclosure provided herein.

### BRIEF DESCRIPTION OF THE FIGURES

FIG. 1 illustrates the set up used to test the stability of 1233zd.

FIG. 2 is a picture of different metals after refluxing with 1233zd for 100 hours.

FIG. 3 illustrates the comparative cleaning capacity of perchloroethylene, 1233zd(E) and 1233zd(Z) in removing Mobile 600W oil, as set forth in Example 16.

FIG. 4 illustrates the comparative cleaning capacity of perchloroethylene, trichloroethylene, 50 wt % trans-dichlororethylene+50 wt % HFE-7100, 53% 43-10mee+43% trans-dicholoethylene+4% methanol, 1233zd(E) and 1233zd(Z) in removing used cutting oil, as set forth in Example 17.

### DETAILED DESCRIPTION OF THE INVENTION

The present invention relates, in part, to compositions and uses of compositions including halo-olefin solvents, inter alia, as compositions for industrial cleaning of a variety of substrates.

For purposes of the present invention, an HCFO may be any hydrohalocarbon with chlorine and fluorine atoms attached to any of the carbons and any one of the carbon-carbon bonds being a double bond. Similarly, an HFO is any hydrohalocarbon with fluorine atoms attached to any of the carbons and any one of the carbon-carbon bonds being a double bond.

In certain aspects, the HCFO and HFO solvents of the present invention include one or more C2 to C6 fluoroalkenes or one or more C3, C4, or C5 fluoroalkenes, which may be generically represented by Formula B as follows:

XCF_{z}R_{3-z}(B)

where X is a C₂, C₃, C₄ or C₅ unsaturated, substituted or unsubstituted, radical, each R is independently Cl, F, Br, I or H, and z is 1 to 3. In certain embodiments, the fluoroalkene of the present invention has at least four (4) halogen substituents, at least three of which are F and even more preferably none of which are Br. In even further embodiments, the compound of formula B comprises a compound, and preferably a three carbon compound, in which each non-terminal unsaturated carbon has a fluorine substituent.

Suitable HCFOs and HFOs may also be represented one or more compounds having the structure of formula (I):

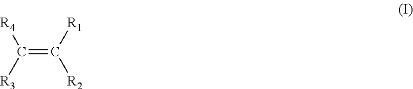

wherein R₁, R₂ R₃, and R₄ are each independently selected from the group consisting of: H, F, Cl, and C₁-C₆ alkyl, at least C₆ aryl, in particular C₆-C₁₅ aryl, at least C₃ cycloalkyl, in particular C₆-C₁₂ cycloalkyl, and C₆-C₁₅ alkylaryl, optionally substituted with at least one F or Cl wherein formula (I) contains at least one F, and preferably at least one Cl.

Suitable alkyls include, but are not limited to, methyl, ethyl, and propyl. Suitable aryls include, but are not limited to phenyl. Suitable alkylaryl include, but are not limited to methyl, ethyl, or propyl phenyl; benzyl, methyl, ethyl, or propyl benzyl, ethyl benzyl. Suitable cycloalkyls include, but are not limited to, methyl, ethyl, or propyl cyclohexyl. Typical alkyl group attached (at the ortho, para, or meta positions) to the aryl can have C₁-C₇ alkyl chain. The compounds of formula (I) are preferably linear compounds although branched compounds are not excluded.

Non-limiting examples of such a solvent compound include compounds having the formula C₃F₃H₂Cl (HCFO-1233), C₄H₂F₆ (HFO-1336), CF₃CF═CFCF₂CF₂Cl and CF₃CCl═CFCF₂CF₃, and mixtures thereof.

The term “HCFO-1233” or “1233” is used herein to refer to all monochloro-trifluoropropenes. Among the monochloro-trifluoropropenes included is 2-chloro-1,1,1-trifluoropropene (HCFO-1233xf) and 1-chloro-3,3,3-trifluoro-propene (HCFO-1233 zd). The term HCFO-1233zd is used herein generically to refer to 1-chloro-3,3,3-trifluoropropene, independent of whether it is the cis- or trans-form. The terms “cis HCFO-1233zd” and “trans HCFO-1233zd” are used herein to describe the cis- and trans-forms of 1-chloro-3,3,3-trifluoropropene, respectively. The term “HCFO-1233zd” therefore includes within its scope cis HCFO-1233zd, trans HCFO-1233zd, and all combinations and mixtures of these.

Non-limiting substrates intended for use with the present compositions include: cotton, polyester, nylon, rayon, silk, wool, chenille, faux fur, tapestry, velvet, taffeta, velveteen, tweed, ultra-suede, suede cloth, leather and various types of materials used in the garment industry; metals, such as steel, stainless steel, aluminum and aluminum alloys, copper and brass; glass and ceramic surfaces, such as borosilicate glass and unglazed alumina; silica, such as silicon wafers; fired alumina; and the like. Additional substrates include plastics and elastomers including, but not limited to, acrylonitrile-butadiene-styrene (ABS), nylon, polycarbonate, polypropylene, polyetherimide, polyethylene terephthalate, poly-vinyl chloride, high-impact polystyrene, acrylic, Viton®B, epichlorohydrin, Buna N, butyl rubber, polyurethane 390, neoprene, silicone, and Kalrez®.

Compositions of the present invention can be used as a solvent to clean various soils from such substrates including, but not limited to, water-based soils, mineral oil, rosin based fluxes, silicon oils, lubricants, refrigerant-based oils, vacuum pump oil, cutting oil, solder flux, etc. Methods of removing such soils, generally speaking, include dry cleaning, wiping, vapor degreasing, spraying or other means identified herein or otherwise known in the art.

### Industrial Cleaning Application

After extensive study, testing and analysis, applicants have determined that the performance of HCFO-1233zd, particularly HCFO-1233zd(E), compares quite favorably with existing solvents, such as CFC-113, making it an excellent replacement, while providing dramatically superior environmental properties. In fact, HCFO-1233zd(E) has a slightly lower boiling point than CFC-113, which provides it with an advantage in certain applications where faster evaporation is required. Another advantage of HCFO-1233zd(E) is its high heat of vaporization. Because of the high heat of vaporization it vaporizes slowly even when used at temperatures above the boiling point of the material. Importantly, 1233zd(E) has a very low surface tension of 12.7 dynes/cm and Kauri-Butanol value of 25. As a result, it is excellent for use in cleaning application. In particular, and as demonstrated herein, it is excellent for use in applications where there is a need to penetrate narrow spaces, e.g. under surface mounts of printed circuit boards, screw threads, areas of tight clearance, dead end holes, small channels and any other area that has restricted access. While not necessarily limited thereto, a confined or narrow space, as used in accordance with the present invention may include a space have a maximum diameter or distance between two walls of less than 1 cm, in certain aspects less than 1 mm, and further aspects less than 0.5 mm, and in even further aspects, less than 0.2 mm.

In certain preferred embodiments, the present invention provides solvent compositions and method for precision cleaning of articles or portions of articles having narrow or confined spaces. In certain of such embodiments, it is preferred that the solvent or cleaning composition comprises trans-1-chloro-3,3,3-trifluoropropene and at least one co-solvent in amounts effective to provide said composition with a surface tension of not greater than about 20 dynes/cm, more preferably not greater than about 16 dynes/cm, and even more preferably not greater than about 15 dynes/cm. In certain of such embodiments, the composition has a surface tension of not greater than about 14 dynes/cm and even more preferably not greater than about 13 dynes/cm.

In certain preferred embodiments, the present invention provides solvent compositions and method for precision cleaning of articles or portions of articles having narrow or confined spaces wherein the solvent or cleaning composition comprises trans-1-chloro-3,3,3-trifluoropropene and at least one co-solvent in amounts effective to provide said composition with a Kauri-Butanol value of at least about 50, more preferably at least about 40 dynes/cm, more preferably at least about 30 dynes/cm. In certain of such embodiments, the composition has a Kauri-Butanol value according to the preferred values mentioned herein and at the same time a surface tension according to one of the preferred values mentioned herein.

Compositions of the present invention, in certain aspects, may include the solvent compound alone, particularly HCFO-1233zd(E) where penetration of a narrow space or precision cleaning is required. In certain applications, however, a co-solvent or co-agent may be used, which may be specifically tailored for one or more of the uses provided herein. Co-agents or co-solvents may include, but are not limited to one or more of water, linear, branched and cyclic hydrocarbons, halocarbons (including fluorinated, brominated and/or chlorinated halocarbons—e.g. n-propyl bromide and trans-1,2-dichloroethylene), alcohols (include C₁-C₅ alcohols), surfactants, ketones, esters, ethers acetals and the like. Additional co-solvents and co-agents will be readily apparent to one of skill in the art, particularly, though not exclusively, on the basis of the uses identified herein.

In printed circuit board applications, the co-agent/co-solvent may be an alcohol. The alcohol may be provided in any effective or sufficient amount to facilitate the cleaning applications discussed herein. As used herein the terms “alcohol” or “alcohol co-solvents” include any one or combination of alcohol containing compounds that are soluble in HCFO-1233zd, particularly HCFO-1233zd(E). Such alcohols may include, in certain non-limiting embodiments, one or more straight or branched chain aliphatic carbon moieties having between 1 and 5 carbons. In further embodiments, the alcohols may include between 1 and 3 carbons. In even further embodiments, the alcohols include methanol, ethanol, isopropanol, isomers or combinations thereof.

The effective amount of alcohol may include any amount, such as the foregoing, where the solvent-alcohol compositions of the invention clean and/or displace soil from a broad range of substrates, such as printed circuit boards. To this end, the effective amount may vary widely depending on the application and will be readily apparent to those skilled in the art. In one aspect, the effective amount of solvent and co-solvent alcohol used may be any amount to remove dirt or debris from the surface of the substrate to be cleaned. An effective amount of alcohol is any amount that is needed for the soil repellency capability of HCFO-1233zd to any extent. By way of non-limiting example, the amount of alcohol used can be any amount between about 0.1 to about 50 weight percent or about 1 to about 30 weight percent, based on the total weight of the composition.

The manner of contacting the substrate with the composition in accordance with the foregoing is not critical and may vary widely. For example, the substrate may be immersed in a container of the composition or the substrate may be sprayed with the composition in an aerosol spray, or otherwise applied using methods known in the art. Complete immersion of the substrate is preferred, though not limiting, because it ensures contact between all exposed surfaces of the substrate and the composition. Any method that can provide such contact may be used. Typically, the contacting time is from about 10 minutes to 30 minutes, but this time is not critical and longer times may be used if desired.

The contacting temperature may also vary widely depending on the boiling point of the compositions. In general, the temperature is equal to or less than about such boiling point. Following the contacting step, the substrate is removed from contact with the composition and the removal of the composition adhering to exposed surfaces of the substrate is effected by any conventional means such as evaporation.

In general, removal, or evaporation, of the composition is effected in less than about 30 seconds, preferably less than about 10 seconds. Neither temperature nor pressure is critical. Atmospheric or sub-atmospheric pressure may be employed and temperatures above and below the boiling point of HCFO-1233zd may be used. Optionally, additional surfactants may be included in the overall composition as desired.

### Dry Cleaning

For dry cleaning applications, the HFO/HCFO solvent agent may be any of the foregoing, but in certain aspects comprises, consists essentially of, or consists of 1-chloro-3,3,3-trifluoropropene, independent of whether it is the cis- or trans-form. In certain aspects of the invention the solvent comprises, consists essentially of, or consists of the cis-1-chloro-3,3,3-trifluoropropene, which may be used as a drop-in replacement in existing dry cleaning system. Trans-1-chloro-3,3,3-trifluoropropene may also be used in such embodiments or in alternative embodiments, however, such that the dry cleaning compositions of the present invention may comprise, consist essentially of, or consist of either the cis- or trans-isomers, or a combination of both.

While the dry cleaning compositions may be provided using any of the above referenced co-solvents or co-agents, or any other similar agent known in the art for use in a dry cleaning application, in certain embodiments the composition includes one or more surfactants. Surfactants useful in accordance with the instant invention include both non-ionic and anionic surfactants. As used herein the term “non-ionic surfactant” includes any surfactant having a neutral or no charge on its hydrophilic end or head and may include any one or combination of non-ionic surfactants that are soluble in HCFO-1233zd. Exemplified non-ionic surfactants for use in the present invention include, but are not limited to, alcohol polyethenoxylate, alkylphenyl polyethyleneoxylate, alkanolamide, ethylene oxide, propylene oxide, glycol ester, polyglyceryl ester, sorbitan ester, and tertiary acetylenic glycol.

As used herein the term “anionic surfactant” includes any surfactant having a negatively charged hydrophilic end or head and may include any one or combination of anionic surfactants that are soluble in HCFO-1233zd. Exemplified anionic surfactants include, but are not limited to, alkylbenzene sulfonate, alkyl sulfate, alkyl polyoxyethelene phosphate, alpha olefin sulfonate, dialkyl sulfosuccinate, lignin sulfonate, naphthalene sulfonate, and petroleum sulfonate.

The solvent-surfactant compositions of the present invention may be used in one or a combination of cleaning applications, particularly, though not exclusively cleaning substrates. While not intending to be bound by theory, HCFO-1233zd primarily functions to clean the article, including removal of excess surfactant, and to displace any remaining soil from the surface of the article. Thus, the present invention provides a method for dry cleaning an article which comprises the steps of contacting, or exposing, the article to a composition comprising a solvent comprising HCFO-1233zd and effective amounts of a surfactant selected from the classes described above and then removing the solvent-surfactant composition from the article.

The effective amounts of HCFO-1233zd and surfactant used in such compositions may vary widely depending on the application and will be readily apparent to those skilled in the art. In one aspect, the effective amount of solvent used is an amount sufficient to remove surfactant from the surface of the substrate to be dried. An effective amount of surfactant is an amount that is needed for the dry cleaning, water management, or soil repellency capability HCFO-1233zd to any extent. By way of non-limiting example, the amount of surfactant used could be no greater than about 5 weight percent of the total weight of the solvent-surfactant composition. However, larger amounts may be used if after treatment with the composition, the article being dried is treated with a volatile halocarbon having either no or a small amount of surfactant. In certain embodiments, the amount of surfactant is between about 0.005 to about 3.0 weight percent, between about 0.005 to about 0.5 weight percent or between about 0.05 to about 0.3 weight percent. In a certain embodiments for drying applications, the amount of surfactant is at least about 0.005 weight percent, between about 0.005 to about 0.5 weight percent, or between about 0.01 to about 0.2 weight percent. In further embodiments for dry cleaning applications, the surfactant is between about 0.005 to about 3.0 weight percent or between about 0.01 to about 0.5 weight percent is used.

To this end, and in accordance with the foregoing, the composition may include a solvent comprising HCFO-1233zd and one or more of an anionic and/or non-ionic surfactant, wherein the components are present in an effective amount or an amount sufficient to provide drying or dry cleaning. The effective amounts include any amount, such as the foregoing, where the solvent-surfactant compositions of the invention displace soil from a broad range of substrates including, without limitation: cotton, polyester, nylon, rayon, silk, wool, chenille, faux fur, tapestry, velvet, taffeta, velveteen, tweed, ultra-suede, suede cloth, leather and various types of materials used in the garment industry; metals, such as stainless steel, aluminum alloys, and brass; glass and ceramic surfaces, such as borosilicate glass and unglazed alumina; silica, such as silicon wafers; fired alumina; and the like. Further, the compositions of the invention either do not form noticeable emulsions with the displaced water or form only insignificant amounts of such emulsions.

In another embodiment, the invention provides solvent-surfactant compositions useful in processes for treating fabric to impart soil repellency. The compositions comprise a solvent comprising HCFO-1233zd and a surfactant, as provided herein, where the components are present in amounts, such as the foregoing, that are sufficient to provide effective soil repellency. These compositions promote soil removal and, when present in a rinse stage, impart soil repellency. To this end, soil repellency may be provided to a substrate and/or fabric by contacting, or exposing, the substrate and/or fabric to a composition, and then removing the solvent.

The manner of contacting the article with the composition in accordance with the foregoing is not critical and may vary widely. For example, the article may be immersed in a container of the composition or the article may be sprayed with the composition. Complete immersion of the article is preferred because it ensures contact between all exposed surfaces of the article and the composition. Any method that can provide such contact may be used. Typically, the contacting time is from about 10 minutes to 30 minutes, but this time is not critical and longer times may be used if desired.

The contacting temperature may also vary widely depending on the boiling point of the compositions. In general, the temperature is equal to or less than about such boiling point. Following the contacting step, the article is removed from contact with the composition and the removal of the composition adhering to exposed surfaces of the article is effected by any conventional means such as evaporation. Optionally, the remaining minimal amounts of surfactant adhering to the article may be removed further by contacting the article with surfactant free solvent that is hot or cold. Finally, holding the article in the solvent vapor will decrease further the presence of the surfactant residue remaining on the article. Again, removal of solvent adhering to the article is effected by evaporation.

In general, removal, or evaporation, of the composition is effected in less than about 30 seconds, preferably less than about 10 seconds. Neither temperature nor pressure is critical. Atmospheric or sub-atmospheric pressure may be employed and temperatures above and below the boiling point of HCFO-1233zd may be used. Optionally, additional surfactants may be included in the overall composition as desired.

Methods of the present invention may be carried out in a dry cleaning machine available in the marketplace. Illustrative of such drying machines are those described in U.S. Pat. No. 3,386,181, which is hereby incorporated in its entirety by reference. There are a number of manufacturers of dry cleaning machines and their design varies quite widely. Depending on the design, the machine may have the ability to run multiple cycles of dry cleaning and drying and may have the capability of distilling the solvent after use.

In alternative embodiments of the present invention, an alcohol or alcohol co-solvent may be used in the place of the surfactant or in conjunction with the foregoing solvent-surfactant compositions. As used herein the terms “alcohol” or “alcohol co-solvents” include any one or combination of alcohol containing compounds that are soluble in HCFO-1233zd. Such alcohols may include, in certain non-limiting embodiments, one or more straight or branched chain aliphatic carbon moieties having between 1 and 5 carbons. In further embodiments, the alcohols may include between 1 and 3 carbons. In even further embodiments, the alcohols include methanol, ethanol, isopropanol, isomers or combinations thereof. The alcohol may be provided in HCFO-1233zd alone or in combination with one or more of the surfactants provided herein.

The effective amounts of alcohol used in such compositions may vary widely depending on the application and will be readily apparent to those skilled in the art. In one aspect, the effective amount of solvent and co-solvent alcohol used may be any amount to remove dirt or debris from the surface of the substrate to be dried and/or cleaned or otherwise to remove residual surfactant from the substrate. An effective amount of alcohol is any amount that is needed for the dry cleaning, water management, or soil repellency capability of HCFO-1233zd to any extent. By way of non-limiting example, the amount of alcohol used can be any amount between about 0.1 to about 50 weight percent or about 1 to about 30 weight percent, based on the total weight of the composition.

The use of the alcohol co-solvent with HCFO-1233zd may be used in the same methods or dry cleaning machines as discussed above. To this end, and in accordance with the foregoing, the composition may include a solvent comprising HCFO-1233zd and alcohol and, optionally, one or more of an anionic and/or non-ionic surfactant. Each component is present in an effective amount or an amount sufficient to provide drying, dry cleaning, or a soil repellency application particularly in substrates identified herein. In certain, and further aspects, the compositions of the invention either do not form noticeable emulsions with the displaced water or form only insignificant amounts of such emulsions.

For a soil repellency application, HCFO-1233zd in combination with one or more alcohols can be used to effectively dissolve a surfactant and then deliver it to a fabric using a process such as spray or immersion application as discussed above.

The following are examples of the invention and are not to be construed as limiting.

### EXAMPLES

### Example 1

The performance of the solvent-surfactant composition of the invention in the displacement of water was evaluated by placing 35 mL of the solvent 1-chloro-3,3,3-trifluoro-1-propene (in one aspect the cis-isomer and in another aspect the trans-isomer) containing 5000 ppm by weight of Soft-Kleen® surfactant from ADCO, Inc. Then specially prepared swatches with typical water soluble soils from DLI were introduced and the container was shaken for a period of 30 minutes. At the completion of the cycle, significant amount of soil removal was observed from the swatches for compositions containing trans-1-chloro-3,3,3-trifluoro-1-propene and for those containing cis-1-chloro-3,3,3-trifluoro-1-propene.

### Example 2

The experiment from Example 1 was repeated with Top Cat® from ADCO, Inc., another commercially available surfactant. The results similarly showed significant soil removal from swatches.

### Example 3

The experiment from example 1 is repeated but using about 2% methanol in place of the surfactant and results similarly show significant soil removal from swatches.

### Example 4

The experiment from Example 1 is repeated with a nonylphenol ethoxylate surfactant and results show significant soil removal.

### Example 5

The experiment from Example 1 is repeated with a dodecylbenzene sulfonic acid non-ionic surfactant and results show significant soil removal.

### Example 6

The experiment from Example 1 is repeated with a mixture of dodecylbenzene sulfonic acid and nolylphenol ethoxylate and results show significant soil removal.

### Example 7

Some of the properties of 1233zd(E), along with the corresponding properties of other existing solvents used today, are shown below. After extensive study, testing and analysis, it was found that the performance of 1233zd(E) compares quite favorably with CFC-113, making it an excellent CFC-113 replacement, while providing dramatically superior environmental properties. Moreover, the fact that 1233zd has a slightly lower boiling point than CFC-113 is advantageous in certain applications.

One of these advantages, is the high heat of vaporization of 1233zd(E). Because it has a high heat of vaporization, it vaporizes slowly even when used at temperatures above the boiling point of the material. Contrary to a perception that the solvent will readily evaporate at room temperature, it has been found that if the solvent is poured into a beaker at room temperature around 25° C. the solvent takes quite a while to evaporate. However, because of higher vapor pressure, it has to be packaged and handled differently.

Its lower boiling point can also be an advantage in many applications where faster evaporation will be required. Besides being completely non-flammable, 1233zd(E) has a very low surface tension (about 12.7 dynes/cm) and a Kauri-Butanol value of 25, providing it with a balance of penetration ability (low surface tension—compare to water at 72.1 dynes/cm) and solvent power (Kauri-Butanol—compare to CFC-113 at 32). These qualities make it an excellent candidate to become the new environmentally friendly workhorse of solvents, particularly in applications where there is a need to penetrate narrow spacings. A comparison of 1233zd(E) with other commonly used solvents is shown in the Table-1 below. In the table Perc, is used as an abbreviation for perchloroethylene.

TABLE 1
Selected Physical Properties of Solvents

| | | HFC 43- | HFE- | HCFC- | CFC- | n-Propyl | |
|---|---|---|---|---|---|---|---|
| | 1233zd | 10mee | 7100 | 225 | 113 | Bromide | Perc |
| Molecular Weight | 130.5 | 252 | 250 | 203 | 187.4 | 122 | 165.8 |
| Boiling Point (° C.) | 19.52 | 54 | 61 | 54 | 47.6 | 71 | 121.3 |
| Vapor Pressure, | 15.23 | 4.4 | 3.2 | 5.6 | 5.27 | 2.1 | 0.27 |
| psi @20 C. | | | | | | | |
| Heat of Vaporization | 193.9 | 129.7 | 112.4 | 145_{@25° C.} | 144.7 | 246 | 207 |
| (kJ/kg) at bp | | | | | | | |
| Flash Point (° C.) | None | None | None | None | None | None | None |

### Example 8

Table 2, below, provides a comparison of 1233zd(E) and other solvent with respect to various environmental considerations, including Atmospheric Life, Ozone Depletion Potential (ODP), Global Warming Potential (GWP), and Volatility (VOC)

TABLE 2
Environmental Properties of Selected Solvents

| Prop- | 1233zd | HFC 43- | HFE- | HCFC- | n-propyl | |
|---|---|---|---|---|---|---|
| erty | (E) | 10mee | 7100 | 225 | bromide | Perc |
| Atmo- | 26 days | 17.1 yrs | 4.1 yrs | 2.1/6.2 yrs | 16 days | 111 d |
| spheric | | | | | | |
| Life | | | | | | |
| ODP | ~0⁽¹⁾ | ~0⁽¹⁾ | ~0⁽¹⁾ | 0.03 | 0.002-0.03 | ~0⁽¹⁾ |
| GWP₁₀₀ | 1 | 1700 | 320 | 180/620 | N/A | 10 |
| VOC | No⁽²⁾ | No | No | No | Yes⁽³⁾ | Yes |

⁽¹⁾No impact on ozone layer depletion and is commonly referred to as statistically zero.
⁽²⁾BA measured MIR of 0.27.
⁽³⁾Applied for but not granted

The table shows that 1233zd(E) has low Global Warming Potential (GWP) compared to other solvents. It is not photochemically reactive to produce smog in the lower atmosphere. This is measured by an experimentally determined number called maximum incremental reactivity (MIR). To be non-VOC, a chemical has to have MIR less than MIR of ethane (0.27 gms of ozone produced/gm of VOC). MIR of 1233zd(E) is well below that value, therefore, it is expected to be ruled as a non-VOC. Lower lifetime compounds have lower GWP since they do not stay in the atmosphere longer and that results in lower greenhouse warming of the earth.

### Example 9

Applicants compared the solubility of various materials which may be considered as soils to be cleaned in 1233zd(E) in Table 3. The miscibility test was done where equal parts by weight of solvent and oils are mixed together and visual observation was made to see if the soils and the 1233zd(E) remained in a single phase, indicating that the soils were are completely dissolved in the solvent. In all cases, the solvent looked clear and the mixtures are reported as miscible below. This is an initial mode of testing to check how well the solvent performs in dissolving the soils.

TABLE 3
Soil Dissolution in Solvents

| Oil | 1233zd(E) | n-propyl bromide |
|---|---|---|
| Mineral Oil | Miscible | Miscible |
| Solder Flux | Miscible | Miscible |
| Refrigerant oil | Miscible | Miscible |
| Silicone Lubricant | Miscible | Miscible |

The table showed that 1233zd(E) has miscibility properties similar to n-propyl bromide which is a very good solvent. In addition a few other soils were tested for solubility in 1233zd(E). Soils, such as, perfluorinated lubricants, polyalkylene glycols all showed solublity in the 1233zd(E) at greater than 10 percent.

### Example 10

Applicants evaluated the solvent's ability in cleaning parts soiled with oils. In these tests, applicants soiled small 2″ by 1″ stainless steel coupons with various commercial oils used in the field and the coupons were immersed in boiling 1233zd(E) at about ambient pressure for 2 minutes and dried in the solvent vapors. This test was performed in small beakers with condenser coils near its lips which emulated conditions similar to a lab vapor degreaser. Coupons were visually observed for cleanliness and weight changes of the coupons were also noted. Cleaning results are given in the table below and it shows that it removed the soils from stainless steel coupons quite well for almost all the soils except for one. This demonstrates good degreasing efficacy of the solvent 1233zd.

TABLE 4
Soil removal from Coupons Using 1233zd(E)

| Test Soil | % Removed | Test Soil | % Removed |
|---|---|---|---|
| Vacuum pump oil | 99.7 | Mil-PRF-83282 | 100 |
| Cutting oil | 99.3 | Mil-PRF-C-81309 | 98.8 |
| Silicone oil | 99.4 | VV-D-1078 | 97.7 |
| Mineral oil | 99.8 | Nye oil 438 | 72.4 |

### Example 11

Applicants performed a defluxing study with 1233zd(E) and alcohol blend. Small pieces of stainless steel coupons were immersed in boiling solvent at ambient pressure for 2 minutes and dried in the vapor. The laboratory experimental set-up is same as mentioned before with boiling liquid in beaker with condenser coils near the lip. A commercial solder was used in this test. Test results showed that the removal was good by visual observations and gravimetric analysis. The composition showed equal or better performance compared to another commercial solvent/alcohol blends as shown in the Table 5 below.

TABLE 5
Solder Flux removal from coupons

| Solvent | Wt % flux removed |
|---|---|
| 1233zd/alcohol blend | 96.9 |
| HFC-43-10/alcohol blend | 95.3 |

### Example 12

The experiment of Example 10 was repeated with an azeotropic mixture of 1233zd(E) and methanol as a cleaner in defluxing with aerosol spray. Aerosol spray is generally used in a number of cases especially for rework. For this test, the solvent blend was used in conjunction with a propellant and sprayed onto printed circuit boards. Results show that the circuit boards looked clean, and was superior to the results produced in the same test using an azeotropic mixture of 1HFC-43-10 and methanol shown in Table 5 for comparison.

### Example 13

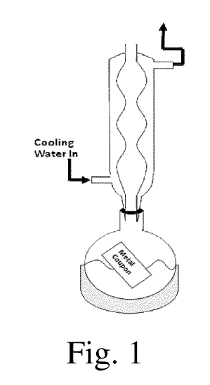

The chemical stability of the compound 1233zd(E) by itself and also in the presence of water, metals, flux is another important factor to be considered in the identification of a successful solvent. To test this, applicants used a setup shown in FIG. 1. As shown in FIG. 1, chilled water cooled condensers were connected to small flasks and the solvents were boiled in the flasks and refluxed back to the flask. This test continued for 2 weeks.

Solvent was boiled with water alone or in presence of various metal coupons such as stainless steel 304, cold-rolled steel, galvanized steel, copper, and aluminum. The coupons were partially immersed in the solvent which allowed the state of the coupons at the interface of liquid and vapor to be viewed. The experiment consisted of refluxing HFO-1233zd (E) with individual metals and added moisture (0.20% H₂O) for a period of 100 hours. After the test, coupons were observed visually for rusting or pitting and the remaining solvent in the flask was examined for breakdown products including chlorides and fluorides which are good indicators of breakdown of solvents. The tests showed that there was no increase of chlorides and fluorides in the solvent over the baseline and no other degradation products indicating that the solvent is quite stable under these conditions. These results are shown in Table 6 (no added moisture) and Table 7 (additional moisture).

TABLE 6
Ion Chromatography Analysis (ppm)/No additional moisture

| Aqueous | | Ace- | For- | | | | | |
|---|---|---|---|---|---|---|---|---|
| Wash | F⁻ | tate | mate | Cl⁻ | Br⁻ | NO₃⁻ | SO₄⁻² | PO₄⁻³ |
| 1233zd | 0.08 | 0.13 | 0.35 | 0.11 | <0.05 | 0.06 | 0.21 | <0.10 |
| (virgin/no | | | | | | | | |
| reflux) | | | | | | | | |
| 1233zd | 0.09 | 0.13 | 0.19 | 0.16 | <0.05 | 0.12 | 0.29 | <0.10 |
| (no metal) | | | | | | | | |
| 1233zd | 0.08 | 0.10 | 0.12 | 0.11 | <0.05 | 0.06 | 0.18 | <0.10 |
| (S.S 304) | | | | | | | | |
| 1233zd | 0.08 | 0.08 | 0.17 | 0.12 | <0.05 | 0.06 | 0.17 | <0.10 |
| (CRS) | | | | | | | | |
| 1233zd | 0.08 | 0.12 | 0.22 | 0.12 | <0.05 | 0.14 | 0.30 | <0.10 |
| (GAL) | | | | | | | | |
| 1233zd | 0.09 | 0.12 | 0.26 | 0.14 | <0.05 | 0.19 | 0.45 | <0.10 |
| (AL) | | | | | | | | |
| 1233zd | 0.09 | 0.12 | 0.10 | 0.9 | <0.05 | 0.12 | 0.41 | <0.10 |
| (CU) | | | | | | | | |

TABLE 7
Ion Chromatography Analysis (ppm)/with 0.2% moisture added

| Aqueous | | Ace- | For- | | | | | |
|---|---|---|---|---|---|---|---|---|
| Wash | F⁻ | tate | mate | Cl⁻ | Br⁻ | NO₃⁻ | SO₄⁻² | PO₄⁻³ |
| 1233zd | 0.05 | 0.08 | 0.12 | 0.08 | <0.05 | <0.05 | 0.23 | <0.10 |
| (no metal) | | | | | | | | |
| 1233zd | 0.06 | 0.04 | 0.08 | 0.07 | <0.05 | <0.05 | 0.18 | <0.10 |
| (S.S 304) | | | | | | | | |
| 1233zd | 0.05 | 0.07 | 0.14 | 0.07 | <0.05 | 0.10 | 0.26 | <0.10 |
| (CRS) | | | | | | | | |
| 1233zd | 0.05 | 0.04 | 0.08 | 0.07 | <0.05 | <0.05 | 0.19 | <0.10 |
| (GAL) | | | | | | | | |
| 1233zd | 0.05 | 0.04 | 0.10 | 0.08 | <0.05 | <0.05 | 0.18 | <0.10 |
| (AL) | | | | | | | | |
| 1233zd | 0.06 | 0.09 | 0.16 | 0.08 | <0.05 | 0.15 | 0.31 | <0.10 |
| (CU) | | | | | | | | |

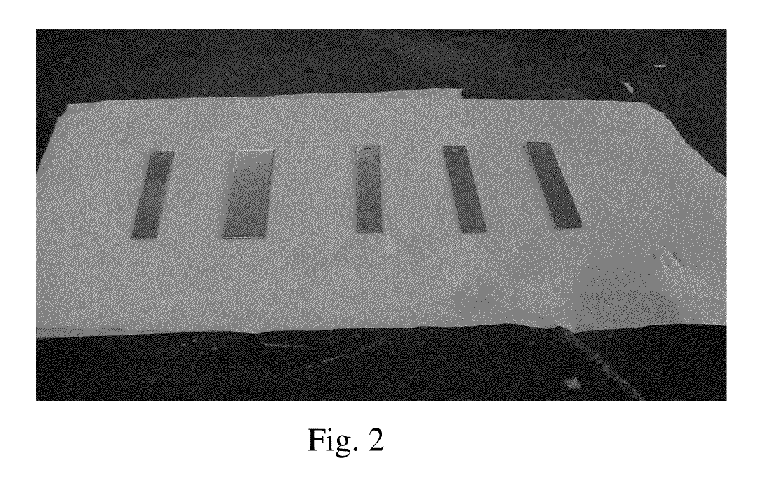

The test coupons also showed no rusting or pitting. Similar tests also continued with addition of solder flux in the liquid and in that case also solvent showed excellent stability under these adverse conditions. Additionally, the solvent did not turn acidic which has been a problem with some solvent blends which use tr-1,2-dichloroethylene. These results are shown in FIG. 2.

### Example 14

Compatibility of common plastics with 1233zd(E) was also studied. This experiment consisted of immersing commonly used plastics such as acrylonitrile-butadiene-styrene (ABS), high-density polyethylene (HDPE), nylon, polycarbonate, polypropylene, polyetherimide, polyethylene terephthalate, poly-vinyl chloride, high-impact polystyrene, acrylic in the solvent for 2 weeks at room temperature in enclosed cells. At the end of 2 weeks, they were taken out and weight and volume changes were recorded. Except for high-impact polystyrene and acrylic, all other plastics have minimal or no effect.

### Example 15

The experiment of Example 14 was repeated with elastomers. Elastomers used in the compatibility test are Viton®B, epichlorohydrin, Buna N, butyl rubber, buna-nitrile, polyurethane 390, neoprene, silicone, Kalrez® and EPDM. Again weight change and dimensional change were carried out along with visual observation for cracks or other degradation. For all of the elastomers, with the exception of Buna-nitrile and EPDM, only minimal changes were observed.

### Example 16

In precision cleaning it is essential that oils are completely removed after the cleaning step. One area that has been very difficult to clean is in confined spaces. Confined spaces (as defined above) in certain aspects can items with diameters or distances between two adjacent walls like screw threads, areas of tight clearance, dead end holes, small channels and any other area that has restricted access. Typically confined space cleaning is required in a number of areas such as precision metal, electronics, medical and plastics cleaning. A test was designed to evaluate the cleaning of confined spaces. This test consists of a glass rod that has a hole machined down the center. The oil is then packed inside rod and cleaned by typical immersion cleaning processes. The ability to use 1233zd(E) or 1233zd(Z) as a precision cleaner was determined in the following example.

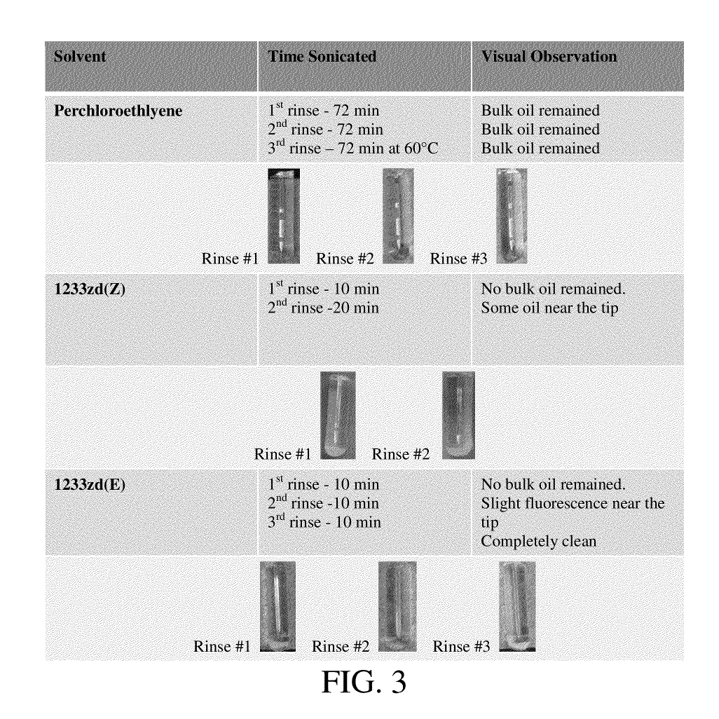

A glass capillary was constructed that has a radius of 0.16 mm and a length of 15 mm The glass capillary was then filled with Mobile 600W oil. The Mobile 600W oil fluoresces readily under an ultraviolet light so that the all residue can easily be seen. The capillary was then immersed in solvent and sonicated for a given amount of time. The ultraviolet light was then used to inspect for cleanliness of the capillary. The results for cleaning with perchloroethylene, 1233zd(E) and 1233zd(Z) are given in FIG. 3. Both the E and Z isomers of 1233zd cleaned more efficiently and at lower temperatures than perchloroethlyene. 1233zd(E) showed increased cleaning performance over 1233zd(Z).

### Example 17

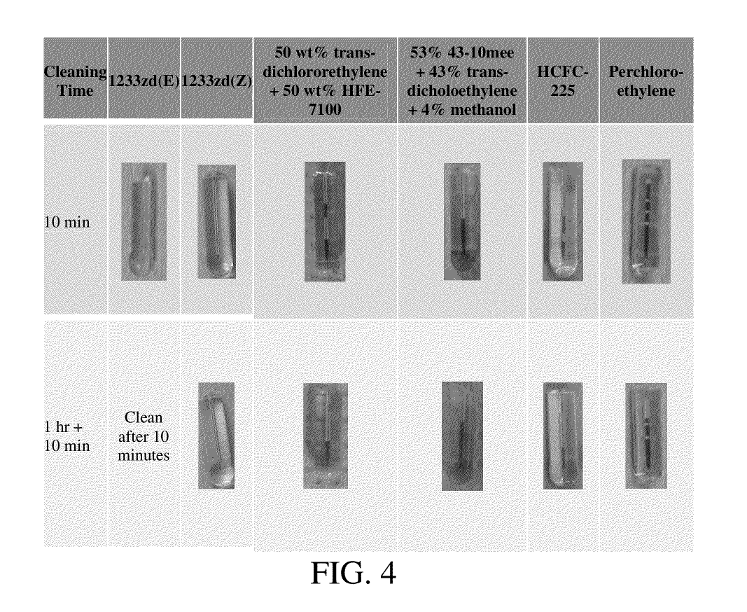

The ability to use 1233zd(E) or 1233zd(Z) as a precision cleaner was determined in the following example. More specifically, and in accordance with Example 16, a glass capillary was constructed that has a radius of 0.16 mm and a length of 15 mm. The glass capillary was then filled with used cutting oil. The capillary was then immersed in solvent and sonicated for a given amount of time. The capillary was then inspected visually to see if any used cutting oil remained. The results for cleaning with perchloroethylene, trichloroethylene, 50 wt % trans-dichlororethylene+50 wt % HFE-7100, 53% 43-10mee+43% trans-dicholoethylene+4% methanol, 1233zd(E) and 1233zd(Z) are given in FIG. 4. The 1233zd isomers are the most efficient cleaners of all the solvents tested. 1233zd(E) showed increased cleaning performance over 1233zd(Z).

What is claimed is:

1. A solvent composition for precision cleaning of articles or portions of articles having narrow or confined spaces, the composition comprising trans-1-chloro-3,3,3-trifluoropropene and at least one co-solvent in amounts effective to provide said composition with a surface tension of not greater than about 16 dynes/cm.

2. The composition of claim 1 wherein said composition has a Kauri-Burtanol value of of not less than about 30.

3. The composition of claim 1 wherein said composition has a Kauri-Burtanol value of of not less than about 25.

4. The composition of claim 1, wherein the alcohol is selected from the group consisting of methanol, ethanol, isopropanol, and combinations thereof.

5. The composition of claim 1, wherein the at least one alcohol is provided in an amount between about 0.1 to about 50 weight percent, based on the total weight of the composition.

6. The composition of claim 1, wherein the at least one alcohol is provided in an amount between about 1 to about 30 weight percent, based on the total weight of the composition.

7. A method for cleaning a printed circuit board comprising, contacting the printed circuit board with the composition of claim 1.

8. A method for precision cleaning by contacting a narrow space of a substrate with a composition comprising trans-1-chloro-3,3,3-trifluoropropene and then removing the composition from the substrate.

9. The method of claim 8 wherein the narrow space has a maximum diameter that is less than 1 cm.

10. The method of claim 8 wherein the narrow space has a maximum diameter that is less than 1 mm.

11. The method of claim 8 wherein the narrow space has a maximum diameter that is less than 0.5 mm.

12. The method of claim 8 wherein the narrow space has a maximum diameter that is less than 0.2 mm.

13. The method of claim 8 wherein said composition has a surface tension of not greater than about 16 dynes/cm.

14. The method of claim 13 wherein said composition has a Kauri-Burtanol value of not less than about 25.

15. A solvent composition for dry cleaning a substrate comprising an effective amount of 1-chloro-3,3,3-trifluoropropene and a co-agent which is selected from the group consisting of at least one non-ionic surfactant, at least one anionic surfactant, at least one alcohol, and combinations thereof.

16. The composition of claim 15, wherein the non-ionic surfactant is selected from the group consisting of alcohol polyethenoxylate, alkylphenyl polyethyleneoxylate, alkanolamide, ethylene oxide, propylene oxide, glycol ester, polyglyceryl ester, sorbitan ester, tertiary acetylenic glycol and combinations thereof.

17. The composition of claim 15, wherein the at least one non-ionic surfactant is provided in an amount between about 0.005 to about 3.0 weight percent, based on the total weight of the composition.

18. The composition of claim 15, wherein the at least one non-ionic surfactant is provided in an amount between about 0.005 to about 0.5 weight percent, based on the total weight of the composition.

19. The composition of claim 15, wherein the at least one non-ionic surfactant is provided in an amount between about 0.05 to about 0.3 weight percent, based on the total weight of the composition.

20. The composition of claim 15, wherein the anionic surfactant is selected from the group consisting of alkylbenzene sulfonate, alkyl sulfate, alkyl polyoxyethelene phosphate, alpha olefin sulfonate, dialkyl sulfosuccinate, lignin sulfonate, naphthalene sulfonate, petroleum sulfonate and combinations thereof.

21. The composition of claim 15, wherein the at least one anionic surfactant is provided in an amount between about 0.005 to about 3.0 weight percent, based on the total weight of the composition.

22. The composition of claim 15, wherein the at least one anionic surfactant is provided in an amount between about 0.005 to about 0.5 weight percent, based on the total weight of the composition.

23. The composition of claim 15, wherein the at least one anionic surfactant is provided in an amount between about 0.05 to about 0.3 weight percent, based on the total weight of the composition.

24. The composition of claim 15, wherein the alcohol is selected from the group consisting of methanol, ethanol, isopropanol, and combinations thereof.

25. The composition of claim 15, wherein the at least one alcohol is provided in an amount between about 0.1 to about 50 weight percent, based on the total weight of the composition.

26. The composition of claim 15, wherein the at least one alcohol is provided in an amount between about 1 to about 30 weight percent, based on the total weight of the composition.

27. The composition of claim 15, wherein the 1-chloro-3,3,3-trifluoropropene is selected from the group consisting of cis-1-chloro-3,3,3-trifluoropropene, trans-1-chloro-3,3,3-trifluoropropene, and combinations thereof.

28. The composition of claim 27, wherein the 1-chloro-3,3,3-trifluoropropene comprises trans-1-chloro-3,3,3-trifluoropropene.

29. The composition of claim 27, wherein the 1-chloro-3,3,3-trifluoropropene consists essentially of trans-1-chloro-3,3,3-trifluoropropene.

30. The composition of claim 27, wherein the 1-chloro-3,3,3-trifluoropropene consists of trans-1-chloro-3,3,3-trifluoropropene.

31. The composition of claim 27, wherein the 1-chloro-3,3,3-trifluoropropene comprises cis-1-chloro-3,3,3-trifluoropropene.

32. The composition of claim 27, wherein the 1-chloro-3,3,3-trifluoropropene consists essentially of cis-1-chloro-3,3,3-trifluoropropene.

33. The composition of claim 27, wherein the 1-chloro-3,3,3-trifluoropropene consists of cis-1-chloro-3,3,3-trifluoropropene.

34. A method for dry cleaning an article comprising the steps of contacting the article with and effective amount of the composition of claim 15 and then removing the composition from the article.

35. A method for imparting soil repellency to a fabric, comprising the steps of contacting or exposing the fabric to and effective amount of the composition of claim 1 and then removing the solvent from the fabric.
